(19) United States
(12) Patent Application Publication
(10) Pub. No.: US 2005/0189668 A1
(43) Pub. Date: Sep. 1, 2005

(54) Method and apparatus for producing concrete blocks

(75) Inventor: Ulrich Backs, Kalldof (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hess Maschinenfabrik GmbH & Co. KG, Burbach-Wahlbach (DE)

(21) Appl. No.: 11/053,700

(22) Filed: Feb. 7, 2005

(30) Foreign Application Priority Data
Feb. 26, 2004 (DE) 102004009382.2

(51) Int. Cl. B28B 1/08; B28B 3/02

(52) U.S. Cl. 264/40.1; 425/145; 425/432; 264/333; 264/71

(57) ABSTRACT

The invention relates to a method and an apparatus for producing concrete blocks, in which concrete mortar (14) is moved across a mould (7) by means of a filling carriage (4) and the mould (7) is filled with concrete mortar (14) from the filling carriage (4), whereupon the filling carriage (4) is returned and the concrete mortar (14) located in the mould (7) is compacted first of all by means of a plunger (13), movable from above in the direction of the mould (7), and then by vibration, the plunger (13) being moved via two synchronized motors (15) located one behind the other in the direction of travel of the filling carriage (4) and the torques exerted by said motors (15) being measured, the filling operation of the mould (7) being corrected in accordance with the deviation of actual values, derived from the difference in the measured torques, from predetermined desired values.

### FIELD OF THE INVENTION

The invention relates to a method and an apparatus for producing concrete blocks for constructional purposes.

### BACKGROUND OF THE INVENTION

During the production of concrete blocks, it is known to fill a mould with concrete mortar by means of a filling carriage. In this case, the filling carriage with the concrete mortar is moved horizontally right across the mould, so that the concrete mortar can fall into the mould. In the process, filling errors occur due to non-uniform filling. For example, the mould is filled to a greater extent at the side which the filling carriage reaches first than at the opposite side. The concrete mortar located in the mould is compacted by means of a superimposed plunger, which is displaceable via a central cylinder and is linked via a universal joint, and then further by vibration. In the process, defects on the end products, for instance concrete blocks, then occur in accordance with the non-uniform filling. In order to correct these defects, it is known to detect them by subsequent measurement in order to then carry out an empirical correction of the filling operation by corresponding adjustments.

For example, during the production of hollow blocks, in which it is the dimensional accuracy that is the important factor, a time measurement is carried out relative to the plunger, i.e. the time that the plunger requires to reach the end of its stroke is measured, the end of the stroke being predetermined on account of the dimensional accuracy. This time depends on the density. Accordingly, the block density is indirectly deduced, and, depending on the measured time value, the density is readjusted via the filling of the mould.

On the other hand, during the production of paving stones, it is a correct density, and not so much a dimensionally accurate block height, that is the important factor. Accordingly, work is carried out in this case with a firmly set vibrating time, and the resulting block height which is determined by the end point of the plunger stroke is used as correction parameter.

### SUMMARY OF THE INVENTION

It is an object of the invention is to provide a method for producing concrete blocks which enables the filling parameters for the mould to be derived directly in order thus to ensure a uniform product quality.

It is a further object of the invention to provide an apparatus for producing concrete blocks which enables the filling parameters for the mould to be derived directly in order thus to ensure a uniform product quality.

According to the present invention, by virtue of the fact that a plunger used for the initial compaction of the concrete mortar poured into the mould is moved via at least two synchronized motors and the torques exerted by said motors are measured, the filling operation of the mould being corrected in accordance with the deviation of actual values, derived from the difference in the measured torques, from predetermined desired values, the filling parameters for the filling operation are derived directly, as a result of which it is possible to produce products of uniform quality.

Further embodiments, objects and advantages of the invention can be gathered from the description below.

### BRIEF DESCRIPTION OF THE DRAWINGS

The invention will now be explained in more detail below with reference to an exemplary embodiment shown in the attached figures.

FIG. 1 schematically shows a filling apparatus for a concrete-block-producing machine in side view.

FIG. 2 schematically shows a compacting station for a concrete-block-producing machine in front view.

FIG. 3 schematically shows the compacting station of the machine of FIG. 2 in plan view.

### DETAILED DESCRIPTION OF THE PREFERRED EMBODIMENT

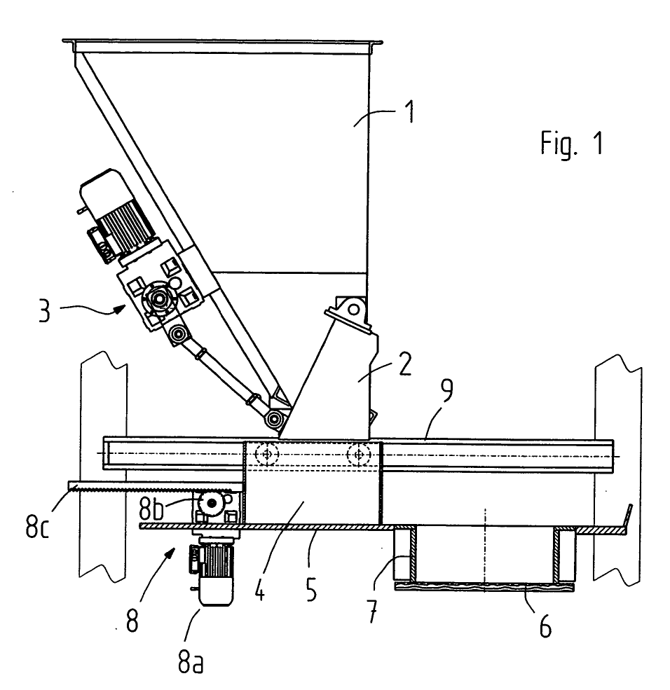

The filling apparatus shown in FIG. 1 comprises a silo 1 with one or more funnel-like outlets and a corresponding number of flaps 2 which are linked to the silo 1 and are movable between an open and a closed position by means of a drive 3 comprising a linkage acting on the flap 2 (one outlet with one flap 2 is provided in the exemplary embodiment). Located below the silo 1 is a filling carriage 4 which is open at the top and bottom and can be moved across a table plate 5 between a position below the flap 2 and a position above a mould 7 for concrete blocks, which is located on a production base 6, by means of a linear drive 8, for example consisting of an electric motor 8a arranged on the filling carriage 4 and of a pinion 8b which is driven by said electric motor 8a and is in engagement with a toothed rack 8c parallel to the table plate 5, or of a piston/cylinder drive, a linear motor or a crank drive. In this case, the filling carriage 4 is guided by a horizontal guide 9 preferably arranged on both sides of the filling carriage 4 and fastened to the machine frame 11.

The production base 6 is located above a vibrating table 10 which can be set in vertical vibrations and is mounted inside the machine frame 11 on damping elements 12, so that vibrations emanating from the vibrating table 10 are in practice not transmitted to the machine frame 11 and the foundations. During the vibration, the vibrating table 10 preferably strikes the production base 6 from below, so that the latter moves upwards and downwards under the effect of gravitational force and is stopped by stop strips 10a during the downward movement.

Arranged in the machine frame 11 is a vertically movable plunger 13 with which concrete mortar 14 located in the mould 7 can be compacted. The plunger 13 can be moved by means of at least two synchronized motors 14 (four motors 15 of this kind in the exemplary embodiment shown). As shown by way of example, this may be effected via pinions 16 and toothed racks 17, which are movably connected in each direction, for instance via a ball joint, to a superimposed load 18, on the underside of which the plunger 13 is located.

Since irregular filling mainly occurs in the direction of travel of the filling carriage 4, the motors 15, if only two of them are used, are expediently to be arranged one behind the other in the direction of travel of the filling carriage 4. However, this also implies that they may be arranged offset relative to the direction of travel and can act, for instance, essentially on the diagonally opposite corners of the mould 7. In the case of four motors 15 in accordance with the exemplary embodiment shown, said motors 15 are arranged in pairs one behind the other in the direction of travel of the filling carriage 4. However, three motors 15 can also be used; for example one motor 15 which acts on that side of the mould 7 which is reached first by the filling carriage 4 during the filling, whereas the other two are arranged adjacent to one another transversely to the direction of travel and act in the region of that side of the mould 7 which is reached last by the filling carriage.

The motors 15 may be electric or hydraulic motors or hydraulic cylinders. They are each coupled to a torque sensor 19, which is expediently a current sensor in the case of an electric motor 15 and a pressure sensor in the case of a hydraulic motor 15. The torque sensors 19 are coupled to a closed-loop control 20 for the drive of the filling carriage 4. In this way, during the production, in accordance with the difference of the measured values of the torque sensors 19 from a predetermined desired value which represents the desired power consumption and which is generally the same for all the motors 15, the filling can be changed, by changing the travel speed or the travel speed profile of the filling carriage 4 during its forward and/or return travel and/or by changing its travel distance (i.e. how far the filling carriage 4 travels across the mould 7 or beyond the latter), in such a way that essentially uniform filling and thus a virtually uniform product quality are always obtained.

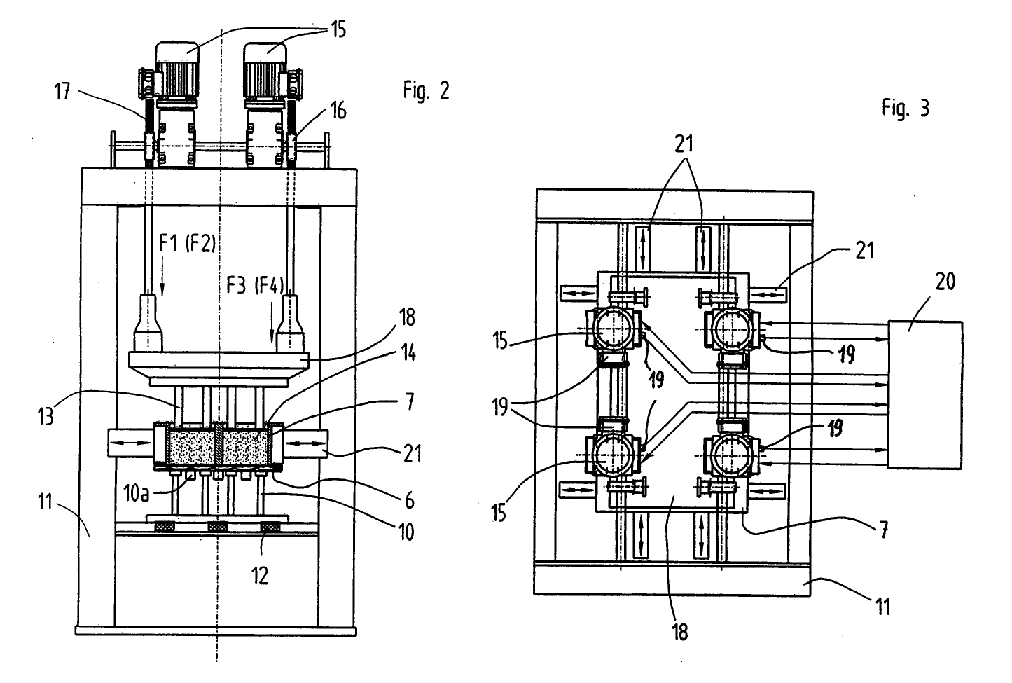

Accordingly, since measurements are taken during every compaction cycle, the filling can be corrected immediately in the event of different torques (caused by different forces F₁, F₂, F₃, F₄ acting on the plunger 13, cf. FIG. 2). This results in a changed concrete-block height or density, depending on whether importance is attached mainly to the dimensional accuracy relating to the height of the blocks—as in the case of hollow blocks—or to the density—as in the case of paving stones.

As shown in FIG. 3, instead of or in addition to the vibrating table 10, at least two vibrators 21 may act in pairs on the mould 7; in the exemplary embodiment shown, eight vibrators 21 are provided in a distributed manner at the periphery of the mould 7 (here in each case two in a respective corner region), the respective vibrators 21 located opposite one another in pairs moving equidirectionally in a synchronized manner.

Furthermore, elasticity compensation of the mechanical equipment, but also of the concrete blocks to be moulded, is effected during the compaction by virtue of the fact that the drive by that motor 15 to which the greater force or the greater torque is assigned runs synchronously with the other motor(s) 15. This avoids a situation in which the superimposed-load side of the plunger 13 in the more poorly filled region sags relative to the well-filled region. The motors 15 are synchronized electronically, for instance via a corresponding displacement measurement.

The lateral vibrators 21 may also be used as filling aids by being operated during the filling of the mould 7. Operated as horizontal vibrators, the vibrators 21 in this case cause the moulding wall of the mould 7 to strike the poured-in concrete mortar 14, as a result of which the sides of the concrete blocks produced are improved. At the same time, by controlling the force exerted by the vibrators 21, their vibration amplitude and frequency, the filling can be improved and/or made more uniform.

Furthermore, the lateral vibrators 21, by appropriate activation by the closed-loop control 20, may be additionally used for correcting the filling of the mould 7.

While the invention has been shown and described with reference to a preferred embodiment, it should be apparent to one of ordinary skill in the art that many changes and modifications may be made without departing from the spirit and scope of the invention as defined in the claims.

1. A method of producing concrete blocks, wherein concrete mortar is moved across a mould by means of a filling carriage and thereby the mould is filled with concrete mortar from the filling carriage, whereupon the filling carriage is returned and the concrete mortar located in the mould is compacted first of all by means of a plunger, movable from above in the direction of the mould, and then by vibration,
wherein the plunger is moved via two synchronized motors located one behind the other in the direction of travel of the filling carriage and the torques exerted by said motors are measured, the filling operation of the mould being corrected in accordance with the deviation of actual values, derived from the difference in the measured torques, from predetermined desired values.

2. The method according to claim 1, wherein, to correct the filling operation, at least one of the travel speed and the travel distance of the filling carriage is chanted.

3. The method according to claim 1, wherein the torques are measured via the current consumption of the motors.

4. The method according to claim 1, wherein more than two synchronized motors are used.

5. The method according to claim 1, wherein the mould is vibrated during the filling.

6. The method according to claim 1, wherein the mould is laterally vibrated for corrected the filling operation.

7. An apparatus for producing concrete blocks, having a mould, a filling carriage moveable right across the mould, a plunger moveable from above relative to the mould, and a vibration device for the mould, the plunger being moveable via two synchronized motors located one behind the other in the direction of travel of the filling carriage, and the motors being coupled to torque sensors, from the measured values of which actual values are derivable for a closed-loop control for the filling operation of the mould in accordance with predetermined desired values.

8. The apparatus according to claim 7, wherein, to correct the filling operation, at least one of the travel speed and the travel distance of the filling carriage are changeable.

9. The apparatus according to claim 7, wherein the torque sensors are current sensors.

10. The apparatus according to claim 7, wherein more than two synchronized motors are provided, at least two of which are located one behind the other in the direction of travel of the filling carriage.

11. The apparatus according to claim 7, wherein at least two vibrators which can be operated during the filling of the mould are provided for horizontally vibrating the mould.

12. Apparatus according to claim 11, characterized in that the vibrators can be set with regard to exerted force, vibration amplitude and frequency.

13. Apparatus according to claim 11, characterized in that vibrators can be used to correcting the filling operation of the mould.
